(19) United States
(12) Patent Application Publication
(10) Pub. No.: US 2006/0033447 A1
(43) Pub. Date: Feb. 16, 2006

(54) Method and apparatus for a TFT array

(75) Inventors: Kiyoshi Chikamatsu, Kanagawa (JP); Kayoko Tajima, Tokyo (JP)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: AGILENT TECHNOLOGIES, INC.

(21) Appl. No.: 11/173,789

(22) Filed: Jul. 1, 2005

(30) Foreign Application Priority Data
Aug. 13, 2004 (JP) 2004-236090

(51) Int. Cl. G09G 3/10

(52) U.S. Cl. 315/169.3

(57) ABSTRACT

A testing method for a TFT array substrate arranging pixels in a matrix where a pixel comprises a pixel selection transistor having a gate formed from a first structural material and a source and a drain formed from a second structural material, and a drive transistor having a gate formed from the first structural material and a source and a drain formed from the second structural material, wherein the testing method comprises: a first step for applying a first voltage to the drain of the pixel selection transistor and initializing the source voltage; a second step for applying a second voltage to the drain of the pixel selection transistor and measuring the current flowing between the drain and source of the pixel selection transistor; and a third step for determining the on-state resistance of the pixel selection transistor from the current and the potential difference between the first voltage and the second voltage.

### FIELD OF THE INVENTION

The present invention relates to a testing method and an apparatus for a TFT array, and more particularly, to a testing method and a testing apparatus for a TFT array substrate using electroluminescent (EL) elements in which the transistors in a pixel are manufactured by the same process.

### DISCUSSION OF THE BACKGROUND ART

The flat panel displays (FPDs) used in personal computer monitors, televisions, and cellular phones are constructed from display elements such as liquid crystal or electroluminescent (EL) elements and a thin-film transistor array (TFT array) for electrically controlling the states of the display elements. As shown in FIG. 1, the TFT array substrate 16 is configured with a plurality of pixels 27 arranged in a matrix. Gate control lines 22 and data lines 20 are disposed horizontally and vertically and connected to the pixels 27. Each pixel is controlled by selecting the pixel to be controlled by a gate control line 22 and a data line 20, and setting the display luminance by the voltage applied to the data line 20.

Over the past few years, organic EL elements having a wider display color range and suited to smaller and lighter weight FPDs have been focused on as the display elements. Organic EL elements have the property of changing the luminance by the drive current. Therefore, a TFT array using EL elements requires a control circuit for controlling the drive current of the EL element by a voltage applied to the data line 20.

FIG. 2 shows a typical structure of a pixel 27 of a TFT array 16 using EL elements. The gate of a pixel selection transistor 23 is connected to a gate control line 22, and the drain to the data line 20. The source of the pixel selection transistor 23 is connected to the gate of the drive transistor 24. The source of the drive transistor 24 is connected to a power supply line 21. A hold capacitor 25 is connected to the gate of the drive transistor 24 and the power supply line 21. The drains of the drive transistors 24 are connected to the EL elements 26 when the FPD panel is completed. In the TFT array 16 state, the EL elements 26 are in the open state because the elements are not sealed.

Next, the operation of the pixel 27 is explained. Since the gate control line 22 normally has 0 V (off voltage) applied, the pixel selection transistor 23 of each pixel is in the off state. When the pixel is controlled, first, −5 V (on voltage) is applied to the gate control line 22 connected to the pixel 27 (selected pixel), which is the control target. Consequently, the conducting state occurs between the drain and source of the pixel selection transistor 23. Then the voltage V corresponding to the desired emitted light luminance is applied to the data line 20. The hold capacitor 25 is charged, and the gate voltage of the drive transistor is held at V. The EL element drive current corresponding to the voltage V flows between the drain and source of the drive transistor 24 because the hold capacitor is connected to the gate and source of the drive transistor 24. However, in the TFT array state, the drive current does not flow because the EL elements are not sealed, and the drains are in the open state.

The TFT array 16 is formed on a glass substrate. FIG. 3(b) is a cross-sectional view of the glass substrate forming the TFT array, and (a) is the corresponding circuit. In the layout relationship shown in (a), the power supply line 21 is divided into two lines, but both lines are electrically connected and are the same line.

The control circuit of the TFT array 16 is formed on the glass substrate 30 coated with a cover coating layer 31. First, polysilicon layers 23p, 24p are formed at the positions opposite the gate layers 23g, 24g of the transistors 23, 24, and p+-type semiconductor layers (polysilicon layer doped with boron) are formed at the positions of the drains and sources. A polysilicon layer 25p is formed at the position opposite the electrode 25g of the hold capacitor 25, and the source layer 23s of the transistor 23 is disposed adjacent to the polysilicon layer 25p.

Each layer is covered by a first insulating layer 32, and metal wiring layers 20m, 28, 29, 21m are disposed at the drains 23d, 24d and the sources 23s, 24s, respectively. The metal wiring layers 20m, 21m are connected to the data line 20 and power supply line 21, respectively. On the top layer of the first insulating layer 32, the gate layer 23g, 24g of the transistors 23, 24 formed from structural materials and the electrode 25g of the hold capacitor 25 formed from the same structural materials are formed. Although not shown, the gate layer 24g of the drive transistor 24 and the source layer of the pixel selection transistor 23 are connected. To realize the circuit shown in FIG. 2, the metal wiring layer 21m and the electrode 25g must also be electrically connected. However, depending on the usage, both do not necessarily have to be electrically connected. A second insulating layer 33 is formed to cover the gate layer 23g, 24g and the electrode 25g, and a protective layer 34 is formed as the top layer.

As is clear from FIG. 3, the pixel selection transistor 23 is formed from a gate layer 23g, drain layer 23d, and source layer 23s. In addition, the drive transistor 24 is formed from a gate layer 24g, drain layer 24d, and source layer 24s. On the TFT array, since the transistors 23, 24 can be formed by sharing the gate layer, insulating layer, and polysilicon layer of the source and drain, the layers are manufactured by the same process.

In this application, the structural materials are the materials forming the transistors or the electrodes of the hold capacitors. For example, the structural material of the gate of the pixel drive transistor 23 is metal forming the gate 23g. The structural material of the drain and source is a p+-type semiconductor forming the drain 23d and the source 23s. The structural material of the gate of the pixel drive transistor 23 does not necessarily have to be metal, but can be a material like tungsten silicon or polysilicon. The structural materials differ with each TFT array depending on the polarities and characteristics of the transistors.

Because the TFT array substrate 16 has a wide area, it is difficult to manufacture with uniform electrical characteristics for the functional components (transistors and hold capacitors) on the substrate over the entire surface. Therefore, the problem is the resulting fluctuations in the drive current flowing between the drain and source of the drive transistor 24 in each pixel produce nonuniformities in the luminance of the emitted light. If the nonuniformities are small, there is no problem in practice, but nonuniformities above a designated level are unsuited to products. Therefore, an apparatus for testing whether luminance nonuniformities are in the manufactured TFT array is required.

The decision on the quality of the TFT array is desired before sealing the EL material because organic EL material is usually expensive. In the state before sealing the EL elements 26, the problem is the drive current cannot be directly measured because the drain terminal of the drive transistor 24 is in the open state.

### SUMMARY OF THE INVENTION

A testing method for a TFT array substrate where pixels are arranged in a matrix and each pixel comprises a pixel selection transistor having a gate formed from a first structural material and a source and a drain formed from a second structural material and a drive transistor having a gate formed from the first structural material and a source and a drain formed from the second structural material, wherein the testing method comprises: applying a first voltage to the drain of the pixel selection transistor and initializing the source voltage; applying a second voltage to the drain of the pixel selection transistor and measuring the current flowing between the drain and source of the pixel selection transistor; and determining the on-state resistance of the pixel selection transistor from the current and the potential difference between the first voltage and the second voltage.

The luminance and the current flowing in the EL element during the pixel display are highly correlated. The current flowing in the EL element is the current flowing in the source and drain of the drive transistor and is highly correlated to the on-state resistance of the drive transistor. The on-state resistance of the pixel selection transistor and the drive transistor are highly correlated. The reason is both transistors are formed close to each other within about 100 μm, and the electrical characteristics of the transistors are very similar due to the manufacturing process. Therefore, by measuring the on-state resistance of the pixel selection transistor, the nonuniformity of the on-state resistance of the drive transistor, that is, the luminance nonuniformity of the TFT array substrate, can be estimated.

The on-state resistance of the pixel selection transistor of the TFT array can be measured. Then by extracting the nonuniformity of the relevant on-state resistance, the luminance nonuniformity of the TFT array can be estimated before sealing the EL elements.

### BRIEF DESCRIPTION OF THE DRAWINGS

FIG. 1 is a schematic view of a TFT array and a testing apparatus.

FIG. 2 is a circuit diagram of each pixel of the TFT array.

FIG. 3 is a cross-sectional view of each pixel on the TFT array substrate.

FIG. 4 is a flow chart of the test.

FIG. 5 is a circuit diagram illustrating the electrical connections between the testing apparatus and each pixel.

### DETAILED DESCRIPTION OF THE PREFERRED EMBODIMENT

Next, with reference to the drawings, a typical embodiment of the present invention is explained.

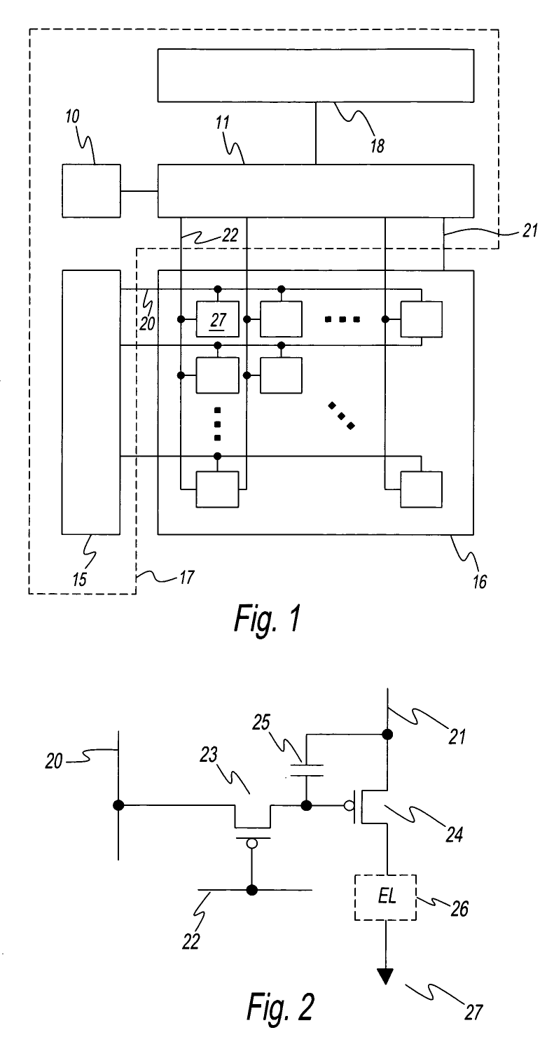

FIG. 1 is a schematic drawing of the TFT array substrate 16 and the testing apparatus 17. The testing apparatus 17 comprises a variable voltage power supply 10 for applying voltage to the data lines 20 of the TFT array 16; an ammeter 15 inserted between a data line 20 and the variable voltage power supply 10 for measuring the current flowing in the data line 20; a control apparatus 11 that is connected to and controls the variable voltage power supply 10, gate control line 22, and power supply line 21 for performing the test; and a processor 18 connected to the control apparatus 11. The processor 18 comprises memory and a processor, and has the functions of storing the calculation result in memory, analyzing the calculation result, calculating the on-state resistance of the pixel selection transistor 23, and extracting the on-state resistance nonuniformity. The variable voltage power supply 10 can be replaced by a plurality of constant voltage power supplies.

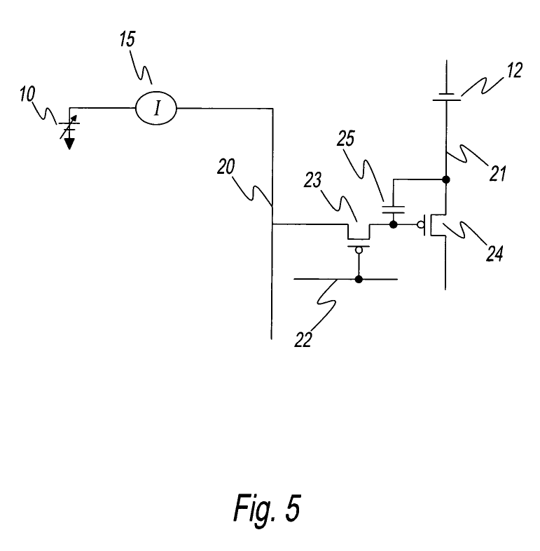

FIG. 5 is a circuit diagram showing the electrical connections between a pixel 27 of the TFT array 16 and an element of the testing apparatus 17. The gate of the pixel selection transistor 23 is connected to the gate control line 22, and the drain to the data line 20. The data line 20 is connected to the variable voltage power supply 10 and the ammeter 15. The source of the pixel selection transistor 23 is connected to the gate of the drive transistor 24 and the hold capacitor 25. The source of the drive transistor 24 and the hold capacitor 25 are connected to the power supply line 21. The power supply line 21 is connected to the power supply 12.

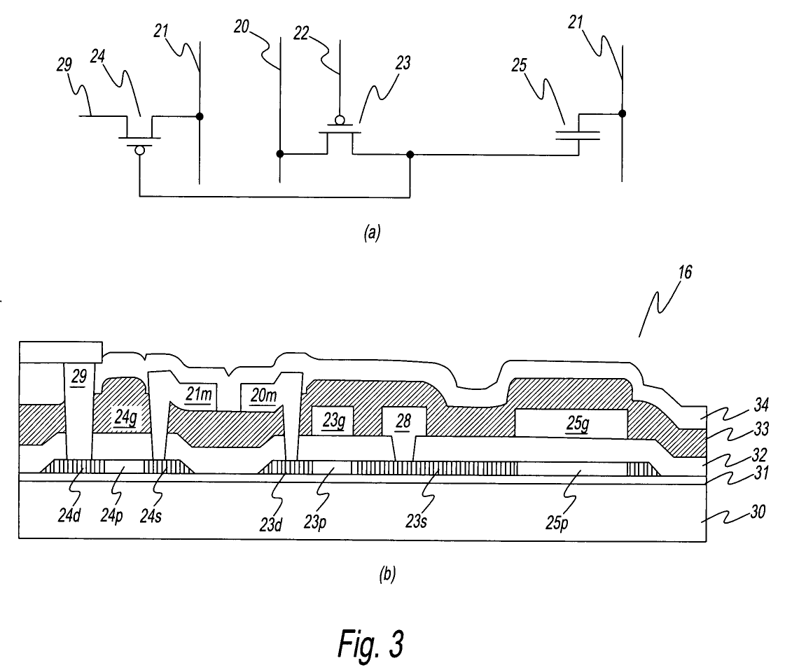

The nonuniformity in the luminance of the emitted light of the TFT array 16 is caused by nonuniformity in the current between the drain and source (EL element drive current) of the drive transistor 24. The nonuniformity in the current between the drain and source of the drive transistor 24 causes nonuniformity in the on-state resistance of the drive transistor 24. The cross-sectional view of the glass substrate of a pixel 27 is the same structure as in FIG. 3, and the drive transistor 24 and the pixel selection transistor 23 are disposed close to each other. The terminals of the gates, drains, and sources of the drive transistor 24 and pixel selection transistor 23 are formed from the same structural material and are manufactured by the same process. Therefore, a high correlation exists in the nonuniformity of the on-state resistance of the pixel selection transistor 23 and nonuniformity of the on-state resistance of the drive transistor 24. Thus, by measuring the on-state resistance of the pixel selection transistor 23, the nonuniformity in the on-state resistance of the drive transistor 24, that is, the luminance nonuniformity of the TFT array 16, can be estimated.

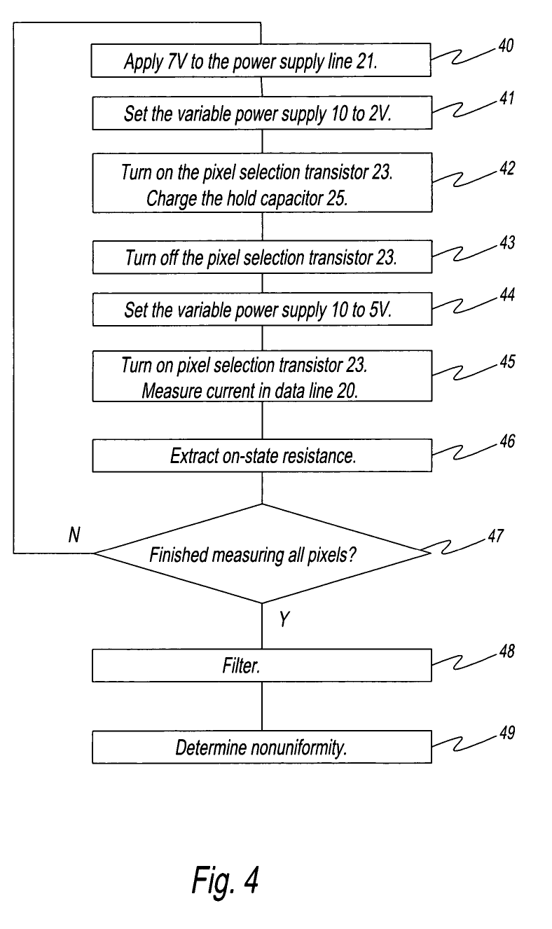

Next, the testing process is explained based on the flow chart in FIG. 4. First, the on-state resistance of the pixel selection transistor 23 of the pixel in the first row and first column is measured. The control apparatus 11 applies 7 V (V0) to the power supply line 21 (Step 40) and sets the output voltage of the variable voltage power supply 10 to 2 V (first voltage V1) (Step 41). In this state, when −5 V is applied to the gate control line 22, the pixel selection transistor 23 turns on, and the hold capacitor 25 charges to 5 V (Vc=V1−V2) (Step 42). Then the voltage applied to the gate control line 22 is temporarily set to 0 V, and the pixel selection transistor 23 turns off (Step 43). Because the voltage of the variable voltage power supply 10 (second voltage V2) is set to 5 V (Step 44), the voltage applied to the gate control line 22 is set again to −5 V. By doing this, a rush current flows because the potential difference of 3 V (Vds=V2−V1) is produced between the drain and source of the pixel selection transistor 23. The current level I of the rush current is measured by the ammeter 15, and the on-state resistance R (=Vds/I) is determined (Step 45). The determined on-state resistance is stored in the memory of the processor 18.

The same measurement process is sequentially applied to the pixel in each column of the first row, then sequentially applied to the pixels in each column from the second row, third row, . . . , last row. The on-state resistance of the pixel selection transistor 23 is determined for all of the pixels and stored in the memory of the processor 18 (Step 46). The distribution data in the surface of the on-state resistance is stored as a 2-dimensional array following the actual sub-pixels in the TFT array 16. The testing apparatus 17 of this embodiment has a function for displaying in gray scale the on-state resistance stored in this 2-dimensional matrix.

Next, a filter is applied to the array of on-state resistances (Step 48). The testing apparatus of this embodiment determines the average of the on-state resistances of a total of five pixels of the current pixel and the four surrounding pixels vertically and horizontally for each pixel. However, this filtering can be the application of other lowpass filters of 2-dimensional data because the object is to remove large gradient information in the 2-dimensional array.

Finally, the processor 18 takes the difference between each array element of the array before filtering and each array element of the array after filtering and determining the nonuniformity of the on-state resistance (Step 49). A pixel having a nonuniformity magnitude above a threshold is judged to be a bad pixel.

The threshold used in the quality decision is determined as follows. The on-state resistance is measured and the nonuniformity is extracted as described above for the TFT array known beforehand to have nonuniformity in the luminance. The difference between the difference of the array element for pixels having luminance nonuniformity and the average of the differences of pixels without luminance nonuniformity is determined. This difference becomes the threshold for the quality decision.

In this embodiment, the on-state resistances of the pixel selection transistors 23 of all of the pixels are measured and the quality decision is made, but the decision can use the measurement results of measuring every couple of pixels in order to shorten the testing time. When a tendency to fluctuate is seen beforehand, designated parts can be focused on and the measurements made and the quality determined. In the process for determining good and bad pixels (Step 49), the array element ratio and not the difference between an array element pair can be taken. Then the quality decision can be made by determining whether the ratio exceeds the threshold. Furthermore, the threshold for the pixel quality decision does not necessarily need to be determined empirically as described above, and the threshold can be a value corresponding to a specified percentage (i.e., 3%) with respect to the average of the on-state resistances of all measured pixels.

The technical concepts of the present invention were explained in detail above while referring to a specific embodiment, but various modifications and innovations can be added without departing from the intent and scope of the claims by a person skilled in the art in fields of the present invention.

What is claimed is:

1. A testing method for a TFT array substrate arranging pixels in a matrix where a pixel comprises a pixel selection transistor having a gate formed from a first structural material and a source and a drain formed from a second structural material, and a drive transistor having a gate formed from said first structural material and a source and a drain formed from said second structural material, wherein the testing method comprises:
applying a first voltage to said drain of said pixel selection transistor and initializing said source voltage of said pixel selection transistor;
applying a second voltage to said drain of said pixel selection transistor and measuring the current flowing between the drain and source of said pixel selection transistor; and
determining the on-state resistance of said pixel selection transistor from said current and the potential difference between said first voltage and said second voltage.

2. The testing method of claim 1, further comprising:
executing the steps of applying a first voltage, applying a second voltage and determining the on-state resistance for a plurality of pixels;
generating a first array arranging said on-state resistances of said plurality of pixels based on the pixel positions;
applying a designated filter to said first array and generating a second array; and
determining the nonuniformity by comparing said first array to said second array.

3. A testing apparatus for a TFT array substrate arranging pixels in a matrix where a pixel comprises a pixel selection transistor having a gate formed from a first structural material and a source and a drain formed from a second structural material, and a drive transistor having a gate formed from said first structural material and a source and a drain formed from said second structural material, wherein the testing apparatus comprises:
at least one power supply for applying the first and second voltages to said drain of said pixel selection transistor;
an ammeter for measuring the drain-source current of said pixel selection transistor;
a controller for applying said second voltage to said drain of said pixel selection transistor after applying said first voltage to said drain of said pixel selection transistor for the designated pixel, and measuring the current flowing by said ammeter when said second voltage is applied; and
a processor for determining the on-state resistance of said pixel selection transistor from said current and the potential difference between said first voltage and second voltage.

4. The testing apparatus of claim 4, wherein said controller has a function for measuring said currents of a plurality of said pixels; and said processor has a function for determining the nonuniformities of the on-state resistances of said pixels.
